(19) United States
(12) Patent Application Publication
(10) Pub. No.: US 2026/0244917 A1
(43) Pub. Date: Aug. 20, 2026

(54) ENCODER-DECODER TRAINING ARCHITECTURE OPTIMIZED FOR INFORMATION EXTRACTION FROM UNSTRUCTURED DATA

(71) Applicant: SAP SE, Walldorf (DE)

(72) Inventor: Tim Breitenbach, Oberleichtersbach (DE)

(21) Appl. No.: 19/057,092

(22) Filed: Feb. 19, 2025

(51) Int. Cl. G06N 3/08; G06F 8/65; G06N 3/0455

(52) U.S. Cl. CPC G06N 3/08; G06F 8/65; G06N 3/0455

(57) ABSTRACT

During machine learning training, encoding and decoding are decoupled into two different processes. In a first process, an untrained version of an encoder is trained by optimizing encoder parameters in order to increase an amount of stochastic dependence between a vector embedding set and ground truth data, where the vector embedding set is generated by the untrained version of the encoder. In a second process, an untrained version of a decoder is trained with the vector embedding set generated by the trained version of the encoder. Output data generated by a trained version of the decoder is provided to one or more software applications to enable the one or more software application to perform one or more tasks.

### TECHNICAL FIELD

The present disclosure generally relates to optimizing an encoder-decoder training architecture for information extraction from unstructured data.

### BACKGROUND

Machine learning models can be used in a variety of applications. For example, machine learning models may be trained to perform a variety of cognitive tasks including object identification, natural language processing, information retrieval, speech recognition, classification, regression, and/or the like.

A neural network model is a type of machine learning model inspired by the structure and function of the human brain. Neural networks can be a powerful tool in artificial intelligence (AI) and machine learning, particularly for tasks that involve complex patterns and large amounts of data. A neural network model can consist of interconnected layers of nodes (i.e., neurons) that process and transmit information. A neural network can include neurons, layers, weights and biases, activation function, a loss function, backpropagation, and a learning rate. Each neuron can be a processing unit that receives input, applies a transformation (often a weighted sum followed by a non-linear activation function), and passes the output to the next layer.

The layers can include an input layer, hidden layers, and an output layer. An input layer can be the first layer that receives the initial data (e.g., pixels of an image, features of a dataset). Hidden layers can include intermediate layers between the input and output layers. These hidden layers perform complex computations and extract features from the data. The number of hidden layers and neurons in each layer can vary, making the network deeper or more complex. The output layer can be the final layer that produces the output or prediction. In classification tasks, this might represent probabilities for different classes.

Weights are parameters that adjust the influence of each input on the neuron's output. Biases are additional parameters added to the input, allowing the model to shift the activation function. Activation functions can introduce non-linearity into the model, allowing it to learn and represent complex patterns. Common activation functions can include but are not limited to rectified linear unit (ReLU), sigmoid, and tanh. Forward propagation can include the process of passing input data through the network, layer by layer, to produce an output. Backpropagation can be an algorithm used to adjust the weights and biases by calculating the gradient of the loss function with respect to each parameter. This can be typically done using a method called gradient descent. A learning rate can be a hyperparameter that controls how much the model's parameters are adjusted during training.

Machine learning model training may require a large volume of data and/or a significant amount of processing time. Generally speaking, training machine learning models can result in intensive consumption of system resources.

### SUMMARY

In some implementations, during machine learning training, encoding and decoding are decoupled into two different processes. In a first process, an untrained version of an encoder is trained by optimizing encoder parameters in order to increase an amount of stochastic dependence between a vector embedding set and ground truth data, where the vector embedding set is generated by the untrained version of the encoder. In a second process, an untrained version of a decoder is trained with the vector embedding set generated by the trained version of the encoder. Output data generated by a trained version of the decoder is provided to one or more software applications to enable the one or more software application to perform one or more tasks.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a diagram of an example of a system, in accordance with some example implementations of the current subject matter;

FIG. 2 illustrates a block diagram of a machine learning model architecture, in accordance with some example implementations of the current subject matter;

FIG. 3 illustrates an example of a process for decoupling an encoder and a decoder during machine learning model training, in accordance with some example implementations of the current subject matter;

FIG. 4 illustrates an example of a process for training an encoder separately from a decoder during machine learning model training, in accordance with some example implementations of the current subject matter;

FIG. 5 illustrates an example of a process for training a decoder separately from an encoder during machine learning model training, in accordance with some example implementations of the current subject matter;

FIG. 6 illustrates an example of a process for optimizing the architecture of an encoder and dimensionality of vector embeddings during machine learning model training, in accordance with some example implementations of the current subject matter;

FIG. 7 illustrates an example of a process for optimizing encoder parameters in order to maximize stochastic dependence between a vector embedding set and ground truth data, in accordance with some example implementations of the current subject matter;

FIG. 8 illustrates a system for implementing one or more machine learning models is depicted, in accordance with some example implementations of the current subject matter;

FIG. 9A depicts an example of a system, in accordance with some example implementations of the current subject matter; and

FIG. 9B depicts another example of a system, in accordance with some example implementations of the current subject matter.

### DETAILED DESCRIPTION

In an example, during machine learning training, encoding and decoding may be decoupled into two different processes. The task for the encoder is to capture the information from the data (e.g., unstructured data) that is important for solving the task. Then, the decoder is trained to solve the task.

Depending on the embodiment, the type of data that is input to the machine learning model may vary. In an example, the data that is input to the system is text. In another example, the data that is input to the system is video. For structured data, there is typically a vector representation. However, unstructured data does not a priori have a vector representation that directly allows for solving tasks, such as image classification where the relevant objects of a figure have to be extracted into such a vector representation.

The representation of the output of the encoder is supposed to share as much information as possible with the ground truth. As used herein, the term “ground truth” may be defined as the actual, correct output expected from a machine learning model for a particular input dataset. The ground truth includes the labels that the machine learning model is supposed to predict. The ground truth may be the next token in the vector representation, a classification, or another type of output.

In an example, the encoder is trained to maximize information between the vector embeddings and the ground truth. As used herein, the term “vector embeddings” may be defined as a numerical vector representation of an object, with the numerical vector representation representing a semantic notion of similarity and dissimilarity between objects in a geometric space. It is noted that the terms “vector embeddings” and “vector embedding set” may be used interchangeably herein.

Later, once parameters in the encoder have been found such that the vector embeddings have the most information as related to the ground truth, the decoder may be trained based on the vector embeddings. During this step, for each input and for each ground truth, the encoder generates a vector embedding set which is the input for the decoder to train the decoder. Accordingly, in an embodiment, the decoder is trained not with the original input, but rather the decoder is trained with the vector embedding sets generated by the encoder.

Based on these approaches, a transformer architecture with an encoder and a decoder may be split. An advantage of this split is that the model is smaller for training. The encoder may be trained with a specific type of loss function or a specific class of loss function. In an example, a cross-entropy loss function is used. In other examples, other types of loss functions may be used, such as loss functions based on stochastic independence. Generally speaking, mutual information is one representation of such a loss function, or any stochastic measure which measures stochastic independence between a vector embedding and the corresponding ground truth representation. As used herein, the term “mutual information” may be defined as a measure of the mutual dependence between two variables. Specifically, “mutual information” quantifies the amount of information obtained about one variable by observing the other variable. The amount of information may be expressed in units such as shannons, nats, or hartleys.

The next step after training the encoder is to train the decoder. In an example, to train the decoder, the parameters of the encoder are fixed, and then the corresponding vector representation output from the encoder is obtained. The vector representation output from the encoder is then provided as an input to the decoder. Then, the decoder parameters are optimized in order to minimize the deviation between the decoder output and the ground truth. In other embodiments, other ways of training the decoder are possible and are contemplated.

In another example, multiple different types of encoders may be trained, and for each different type of encoder, the amount of information in the corresponding generated vector embedding set may be compared to the ground truth set. Then, the different types of encoders may be compared to determine which type of encoder generates a vector embedding set which shares the most information with the ground truth set. For example, a first type of encoder may generate a first vector embedding set which shares a first amount of information with the ground truth set, a second type of encoder may generate a second vector embedding set which shares a second amount of information with the ground truth set, a third type of encoder may generate a third vector embedding set which shares a third amount of information with the ground truth set, and so on. Then, a control engine may determine which type of encoder generates a vector embedding set which shares the most amount of information with the ground truth set. Then, this particular type of encoder may be selected to be used in the machine learning model. Alternatively, different sizes of encoders may be tested, and the amount of stochastic dependence (e.g., mutual information) may be compared to a threshold, and the smallest encoder that meets the stochastic dependence threshold may be selected. In other examples, other factors for determining which type and/or size and/or embedding dimensionality of an encoder to select based on the corresponding amount of information shared with the ground truth set may be utilized. In some cases, information may be lost because the dimensionality of the encoder is too small.

The stochastic dependency between the vector embedding set and the ground truth may decrease as the encoder type, size, and/or dimensionality is changed. There may be a point at which too much information is lost if the dimensionality of the encoder is reduced too much. Stochastic independence, also known as statistical independence, is a concept in probability theory that refers to the relationship between two or more variables. Two variables are said to be stochastically independent if the knowledge about the value of one variable does not provide information about the value of the other variable. As used herein, the term “stochastic dependence” may be defined as a measure of the amount of information obtained about a first variable by observing a second variable.

In an example, stochastic dependence between the vector embedding set and the ground truth may be measured on a scale of 0 to 1, where 1 is maximum information and 0 is minimum information. In other examples, stochastic dependence may be measured on other scales. Generally speaking, loss functions (e.g., mutual information loss functions, chi-square value based loss functions, chi-square test statistic based loss functions) may be used to quantify information content between the encoder output and the ground truth. These loss functions may enable the encoder model and/or architecture to be fine-tuned, as well as allowing fine-tuning of the overall transformer architecture. Any of various type of loss functions may be employed, including, but not limited to, L2, L1, cross-entropy, KL-divergence, mutual information, maximum mean discrepancy, distance correlation, adversarial, Hilbert-Schmidt Independence Criterion, mean squared error, mean absolute error, and Chi Square loss functions. In an example, the loss function measures the stochastic dependence between the encoder output and the ground truth.

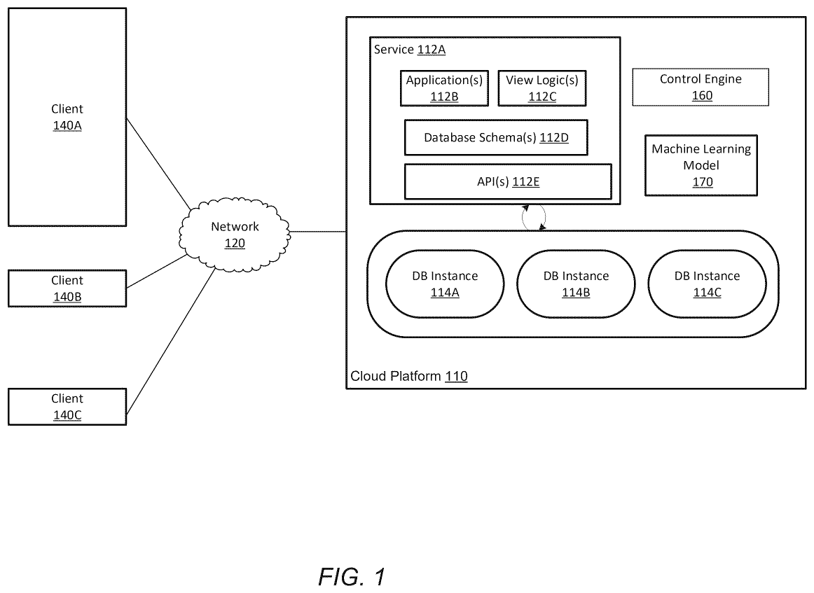

Referring now to FIG. 1, a diagram illustrating an example of a system 100 is depicted consistent with some implementations of the current subject matter. Referring to FIG. 1, the system 100 may include a cloud platform 110. The cloud platform 110 may provide resources that can be shared among a plurality of tenants. For example, the cloud platform 110 may be configured to provide a variety of services including, for example, software-as-a-service (SaaS), platform-as-a-service (PaaS), infrastructure as a service (IaaS), database as a service (DaaS), and/or the like, and these services can be accessed, via network 120, by one or more tenants of the cloud platform 110. Network 120 may be any wired and/or wireless network including, for example, a public land mobile network (PLMN), a wide area network (WAN), a local area network (LAN), a virtual local area network (VLAN), the Internet, and/or the like.

In the example of FIG. 1, the system 100 includes a first tenant 140A (labeled client), a second tenant 140B, and a third tenant 140C, although cloud platform 110 may have other quantities of tenants. The clients may each comprise a user device (e.g., a computer including an application such as a browser or other type of application). The user device may be a processor-based device including, for example, a smartphone, a tablet computer, a wearable apparatus, a virtual assistant, an Internet-of-Things (IoT) appliance, and/or the like. Each client may access, via network 120, at least one of the services at the cloud platform 110. In some implementations, each of the tenants 140A-C represents a separate tenant at the cloud platform 110, such that a tenant's data is not shared with other tenants (absent permission from a tenant). Alternatively, each of the tenants 140A-C may represent a single tenant at the cloud platform 110, such that the tenants do share a portion of the tenant's data, for example.

The cloud platform 110 may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources. In the case of a “public” cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110 includes a service 112A, which is provided to the client 140A. This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service at 112A and served to the client 140A). To illustrate further, client 140A may access the application 112B to view data and/or query data stored in a database instance 114A, for example.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance.

The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which include the database instances 114A-C, also referred to more simply as databases) and the application layer, such as application 112B, which in this example is a multitenant application at the cloud platform 110.

The service 112A may also include an interface 112E to the database layer, such as the database instance 114A and the like. The interface 112E may be implemented as an Open Data Protocol (OData) interface (e.g., HTTP message may be used to create a query to a resource identified via a URI), although the interface 112E may be implemented with other types of protocols including those in accordance with REST (Representational state transfer). In the example of FIG. 1, the database 114A may be accessed as a service at a cloud platform, which may be the same or different platform from cloud platform 110. In the case of REST compliant interfaces, the interface 112E may provide a uniform interface that decouples the client and server, is stateless (e.g., a request includes all information needed to process and respond to the request), cacheable at the client side or the server side, and the like.

The database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110. Although the database instances are depicted at the same cloud platform 110, one or more of the database instances may be hosted on another or separate platform (e.g., on-premise) and/or another cloud platform.

Control engine 160 may manage the training and deployment of machine learning model 170. Control engine 160 may be implemented using any suitable combination of hardware (e.g., circuitry, central processing unit (CPU), application specific integrated circuit (ASIC), field programmable gate array (FPGA), graphics processing unit (GPU), tensor processing unit (TPU)), firmware, and/or software (e.g., machine-readable program instructions). In an example, control engine 160 utilizes machine learning model 170 to perform any of various tasks associated with a database instance 114A-C based on data stored in a table. In another example, control engine 160 utilizes machine learning model 170 to process input data to generate a token or classification based on the input data. In an example, the input data provided to machine learning model 170 is unstructured data.

It is noted that although some of the examples refer to a control engine 160, aspects of the control engine 160 may be deployed in one or more of the database instances 114A-C, the service 112A, the view logic 112C, the application 112B, and/or at other components of the cloud platform 110. Alternatively, in another implementation, control engine 160 and/or machine learning model 170 may be deployed on a server separate from cloud platform 110, such as on an on-premise server. Other ways of deploying control engine 160 and/or machine learning model 170 separately from cloud platform 110 or in conjunction with cloud platform 110 are possible and are contemplated.

Machine learning model 170 is representative of any of various types and/or numbers of machine learning models. For example, machine learning model 170 may be a neural network, recurrent neural network, convolutional neural network, large language model (LLM), generative model, generative neural network, generative adversarial network, generative pre-trained transformer, diffusion model, supervised learning model, unsupervised learning model, reinforcement learning model, linear regression model, and the like. Other types of machine learning models are possible and are contemplated. In some cases, multiple different types of architectures may be combined together into a single machine learning model 170 or multiple machine learning models 170.

Various applications for using machine learning model 170 may be executed by system 100. In an example, a first application may involve fine-tuning for LLMs translating text documents and/or coding models that answer business-related questions. In another example, a second application may involve receiving screenshots of customers reporting technical issues along with text and machine learning model 170 generating potential solutions to these technical issues. In this example, a user may ask to extract certain information from a figure. Alternatively, a user may ask how to make a system work again in a support scenario.

In an example, machine learning model 170 may be trained in a two-part process that decouples the encoder training from the decoder training. In this example, machine learning model 170 may include an encoder-decoder architecture. In this example, in a first step, the encoder portion of machine learning model 170 may be fine-tuned such that for a given data input, the stochastic dependence between the generated vector embedding set and the corresponding ground truth is maximized. Instead of fine-tuning an entire model, which could be relatively large in a multi-modal case, only the encoder portion is trained in a first step in this example. Then, after the encoder portion is trained in the first step, the decoder portion of machine learning model 170 is trained separately in a second step. In an example, the stored vector embedding sets are used to train the decoder portion in the second step. In another example, a trained version of the encoder with fixed parameter values is used to train the decoder portion in the second step.

Another advantage of splitting the training of the entire machine learning model 170 into an encoder training step and a decoder training step is an acceleration in debugging. For example, if the accuracy of the entire machine learning model 170 is not sufficient, then machine learning model 170 may be debugged to determine how to improve its accuracy. During debugging, it may be determined whether a first encoder architecture extracts more information from the input data than a second encoder architecture by comparing the value of a first maximized stochastic dependence between a first vector embedding set and the ground truth for the first encoder architecture to a second maximized stochastic dependence between a second vector embedding set and the ground truth for the second encoder architecture. It should be understood that any number of encoder architectures may be compared in this manner to find the encoder architecture that maximizes the stochastic dependence between the generated vector embedding set and the ground truth. Consequently, it is possible to select the model architecture from a plurality of pretrained models that extracts the most information for the corresponding task, enabling system 100 to find well-fitting model combinations for a specific task. If the information extraction of the encoder is sufficient, in a second step, different decoders can be tested to determine which decoder has the highest accuracy given the vector embedding from the best encoder.

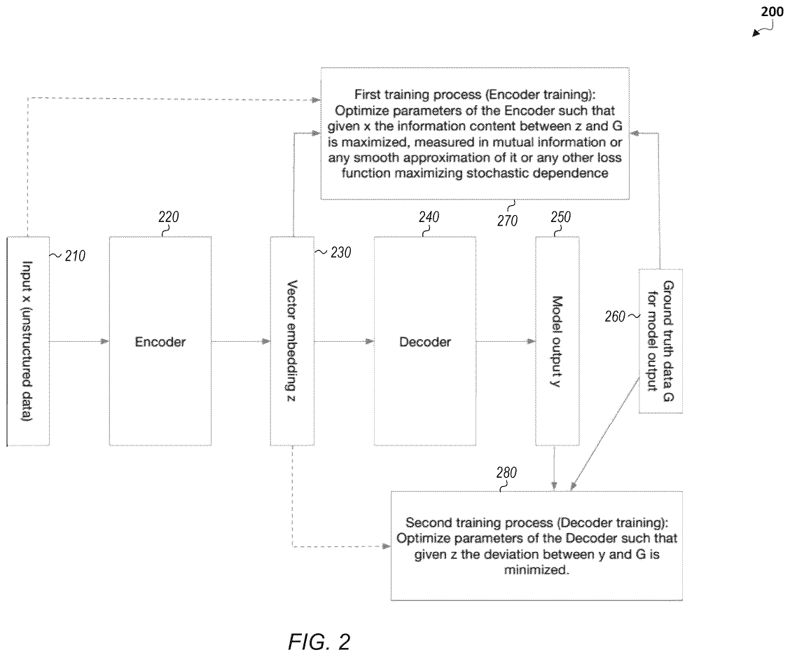

Turning now to FIG. 2, a block diagram of a machine learning model architecture 200 is shown, in accordance with one or more embodiments of the current subject matter. In an example, machine learning model architecture 200 includes input data 210, encoder 220, vector embeddings 230, decoder 240, model output 250, and ground truth data 260. The example nomenclature used for machine learning model architecture 200 includes referring to input data 210 as “x”, referring to vector embeddings 230 as “z”, referring to model output 250 as “y”, and referring to ground truth data 260 as “G”. In some embodiments, input data 210 may be unstructured data, such that the data does not have a representation that contains concentrated information for the prediction task. However, in other embodiments, input data 210 may be structured data (e.g., numerical data). It is noted that machine learning model architecture 200 is merely indicative of one particular embodiment. In other embodiments, other types of machine learning model architectures may be employed.

In an example, the training of the underlying machine learning model, based on architecture 200, is performed in a two-part process which decouples the training of encoder 220 from decoder 240. This allows training to be performed more efficiently using fewer system resources than if the entire machine learning model were to be trained in a single step. Accordingly, a first training process 270 may be performed to train encoder 220. In the first training process 270, the parameters of encoder 220 are optimized such that given x, the information content between z and G is maximized. In an example, the information content between z and G is measured in mutual information. In an example, a smooth approximation of the mutual information is employed. Another approximation may be calculated using a loss function which measures stochastic dependence where mutual information is only one embodiment.

Once the encoder 220 has been trained in the first training process 270, a second training process 280 may be performed to train decoder 240. In the second training process 280, the parameters of the decoder 240 are optimized such that given z, the deviation between y and G is minimized. One embodiment could be L2- or L1-base loss function or cross-entropy. In another embodiment, a loss function based on stochastic independence could be used to minimize the stochastic dependence between the deviation and the vector embedding, which is the input of the decoder. In another embodiment, a combination of different loss functions such as chi-square value based loss functions and chi-square test statistic based loss functions may be employed. It is noted that in the second training process 280, a trained version of encoder 220 may be used to train an untrained version of decoder 240.

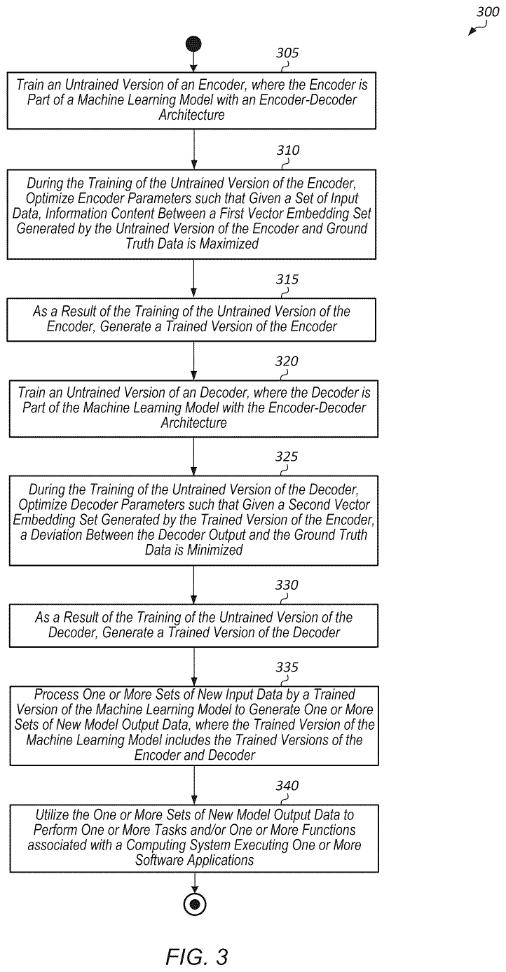

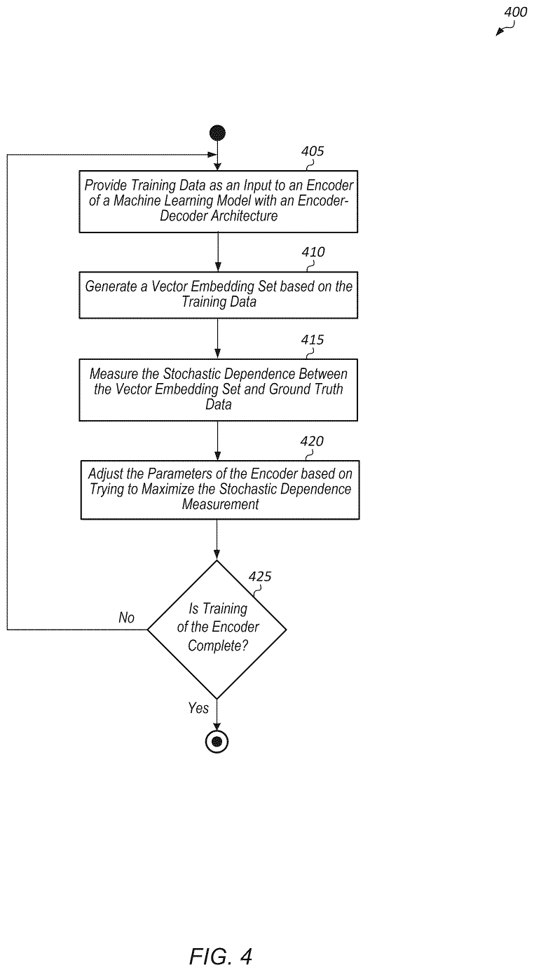

Referring now to FIG. 3, a process for decoupling an encoder and a decoder during machine learning model training is depicted, in accordance with one or more embodiments of the current subject matter. At the beginning of method 300, an untrained version of an encoder is trained, where the encoder is part of a machine learning model with an encoder-decoder architecture (block 305). An example of a process for training an untrained version of an encoder is described in further detail below in the description of FIG. 4. However, in other embodiments, other processes for training an untrained version of an encoder, different than the process described in FIG. 4, may be employed.

During the training of the untrained version of the encoder, parameters of the untrained version of the encoder are optimized such that given a set of input data, information content between a first vector embedding set generated by the untrained version of the encoder and ground truth data is maximized (block 310). In an example, the information content between the first vector embedding set and the ground truth data is measured using a loss function. Then, as a result of the training of the untrained version of the encoder, a trained version of the encoder is generated (block 315).

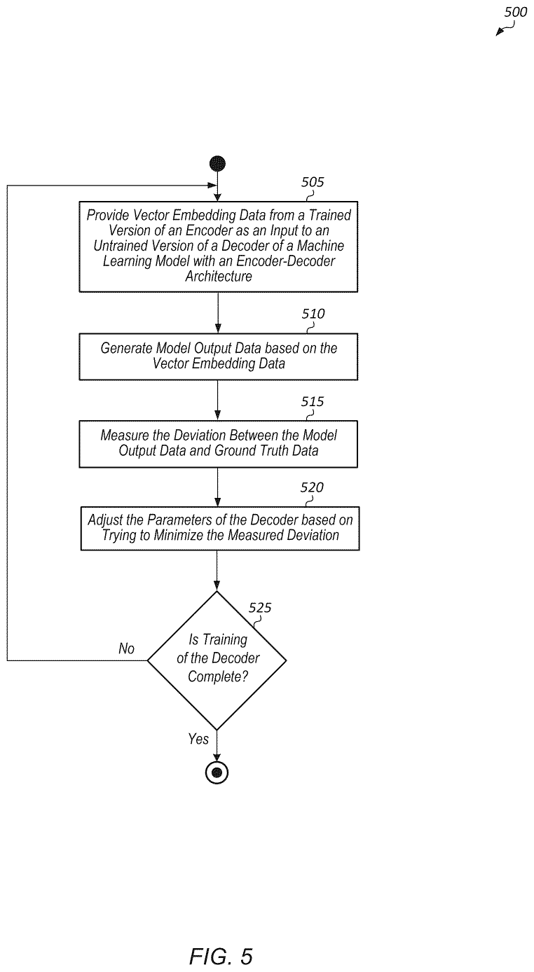

Next, an untrained version of a decoder is trained, where the decoder is part of the machine learning model with the encoder-decoder architecture (block 320). An example of a process for training an untrained version of a decoder is described in further detail below in the description of FIG. 5. However, in other embodiments, other processes for training an untrained version of a decoder, different than the process described in FIG. 5, may be performed.

During the training of the untrained version of the decoder, parameters of the untrained version of the decoder are optimized such that given a second vector embedding set generated by the trained version of the decoder, a deviation between the decoder output and the ground truth data is minimized (block 325). Then, as a result of the training of the untrained version of the decoder, a trained version of the decoder is generated (block 330). Next, one or more sets of new input data are processed by a trained version of the machine learning model to generate one or more sets of new model output data, where the trained version of the machine learning model includes the trained version of the encoder and the trained version of the decoder (block 335). Then, the one or more sets of new model output data are utilized to perform one or more tasks and/or one or more functions associated with a computing system executing one or more software applications (block 340). After block 340, method 300 may end.

Turning now to FIG. 4, a process for training an encoder separately from a decoder during machine learning model training is depicted, in accordance with one or more embodiments of the current subject matter. At the beginning of method 400, training data is provided as an input to an encoder of a machine learning model with an encoder-decoder architecture (block 405). It is noted that the encoder may also be referred to as an untrained version of the encoder. Next, the encoder generates a vector embedding set based on the training data (block 410). Then, the stochastic dependence between the vector embedding set and ground truth data is measured (block 415). In an example, a loss function is used to measure the mutual information between the vector embedding set and ground truth data. Next, the parameters of the encoder are adjusted based on trying to maximize the stochastic dependence measurement (block 420). If the training of the encoder is complete (conditional block 425, “yes” leg), then method 400 may end. In an example, training of the encoder is complete when the stochastic dependence measurement is maximized. In another example, training of the encoder is complete when the stochastic dependence measurement is greater than a threshold. In other examples, other ways of determining that training of the encoder has been completed are possible and are contemplated.

Otherwise, if the training of the encoder is not complete (conditional block 425, “no” leg), then method 400 returns to block 405 with a new set of training data provided as an input to the encoder. During training, one or more parameters (e.g., weights) of the encoder may be modified. In other words, the untrained encoder has one or more first values for one or more parameters while the trained encoder has one or more second values for one or more parameters, where the one or more second values may be different from the one or more first values.

Turning now to FIG. 5, a process for training a decoder separately from an encoder during machine learning model training is depicted, in accordance with one or more embodiments of the current subject matter. At the beginning of method 500, vector embedding data from a trained version of an encoder is provided as an input to an untrained version of a decoder of a machine learning model with an encoder-decoder architecture (block 505). Next, the decoder generates model output data based on the vector embedding data (block 510). Then, the deviation between the model output data and ground truth data is measured (block 515). Next, the parameters of the decoder are adjusted based on trying to minimize the measured deviation (block 520). If the training of the decoder is complete (conditional block 525, “yes” leg), then method 500 may end. In an example, training of the decoder is complete when the deviation between the model output data and ground truth data is minimized. In another example, training of the decoder is complete when the deviation is less than a threshold. In other examples, other ways of determining that training of the decoder has been completed are possible and are contemplated.

Otherwise, if the training of the decoder is not complete (conditional block 525, “no” leg), then method 500 returns to block 505 with a new set of vector embedding data provided as an input to the decoder. During training, one or more parameters (e.g., weights) of the decoder may be modified. In other words, the untrained decoder has one or more first values for one or more parameters while the trained decoder has one or more second values for one or more parameters, where the one or more second values may be different from the one or more first values.

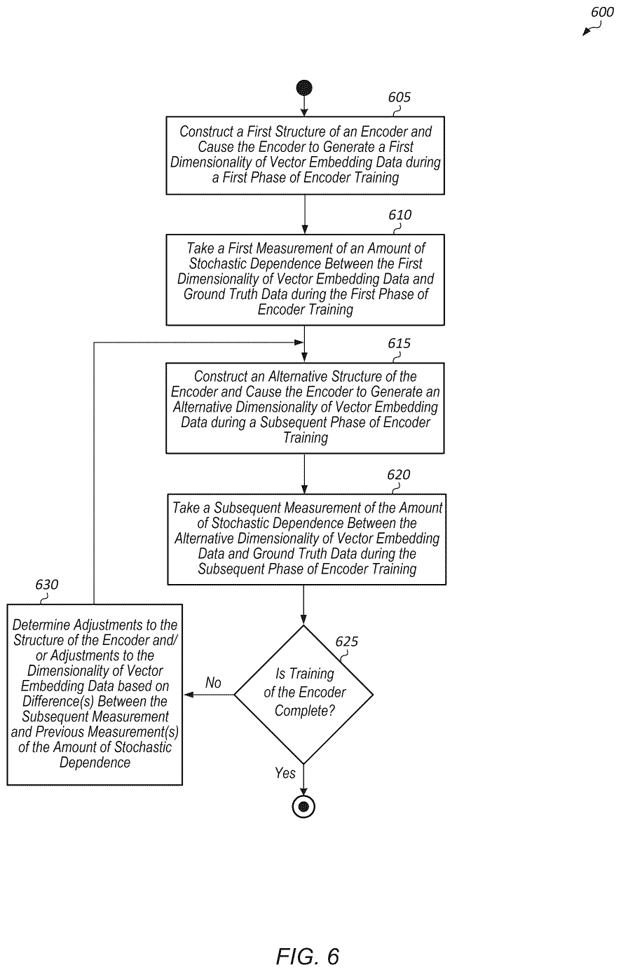

Turning now to FIG. 6, a process for optimizing the architecture of an encoder and dimensionality of vector embeddings during machine learning model training is depicted, in accordance with one or more embodiments of the current subject matter. A first structure of an encoder is constructed and a control engine (e.g., control engine 160 of FIG. 1) causes the encoder to generate a first dimensionality of vector embedding data during a first phase of encoder training (block 605). Next, during a first phase of encoder training, the control engine takes a first measurement of an amount of stochastic dependence between the first dimensionality of vector embedding data and ground truth data (block 610). Then, an alternative structure of the encoder is constructed and the control engine causes the encoder to generate an alternative dimensionality of vector embedding data during a subsequent phase of encoder training (block 615). It is assumed for the purposes of this discussion that the alternative structure of the encoder is different from the first structure of the encoder. The alternative structure may be a different size of the encoder, a different arrangement of layers, a different number of bits per parameter value, and so on. It is also assumed for the purposes of this discussion that the alternative dimensionality of vector embedding data is different from the first dimensionality of vector embedding data. This may require at least one change to at least one parameter while other parameters can be kept unchanged.

After block 615, during the subsequent phase of encoder training, the control engine takes a subsequent measurement of the amount of stochastic dependence between the alternative dimensionality of vector embedding data and the ground truth data (block 620). Next, if the training of the encoder is complete (conditional block 625, “yes” leg), then method 600 may end. In an example, training of the encoder is complete when the adjustments to the structure of the encoder and/or the adjustments to the dimensionality of vector embedding data have resulted in the amount of stochastic dependence being maximized. In another example, training of the encoder is complete when the amount of stochastic dependence is greater than a threshold. In another example, training of the encoder is complete when the amount of stochastic dependence is within a desired range. In another embodiment, the training may end after a fixed set of changes to the encoder are tested and the encoder with the most stochastic dependence is selected. In other examples, other ways of determining that training of the encoder has been completed are possible and are contemplated.

Otherwise, if the training of the encoder is not complete (conditional block 625, “no” leg), then adjustments to the structure of the encoder and/or adjustments to the dimensionality of vector embedding data may be determined based on difference(s) between the subsequent measurement and previous measurement(s) of the amount of stochastic dependence (block 630). After block 630, method 600 returns to block 615 to construct an alternative structure of the encoder for another phase of encoder training. By performing method 600, different variations in the structure of the encoder may be tested to determine how each variation performs based on the amount of stochastic dependence generated between the vector embedding data and ground truth data. This allows designers to fine-tune the encoder for different applications and different systems where the resources available for implementing the encoder may vary and/or where the performance requirements may vary. In another embodiment, by pruning the architecture, an efficient encoder can be determined. Additionally, one can balance the size of an encoder against the loss of information or find a lossless smallest version of an encoder.

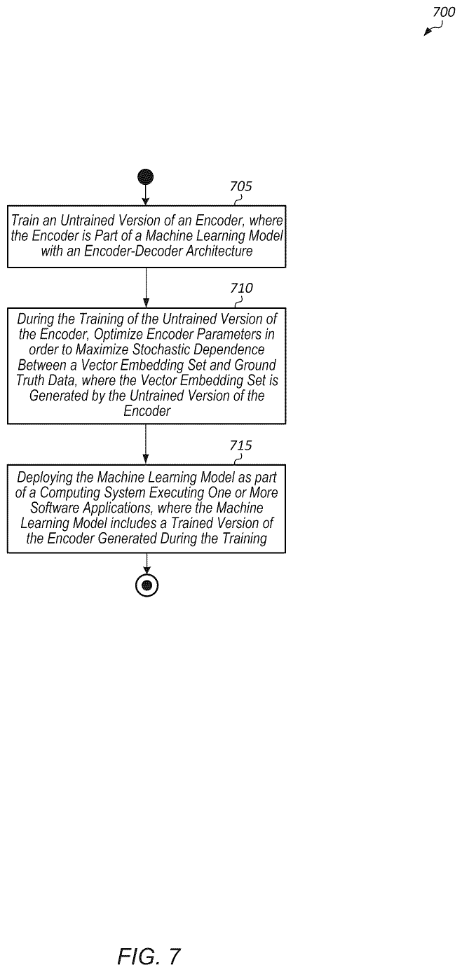

Referring now to FIG. 7, a process for optimizing encoder parameters in order to maximize information content between a vector embedding set and ground truth data is depicted, in accordance with one or more embodiments of the current subject matter. At the beginning of method 700, a control engine (e.g., control engine 160 of FIG. 1) trains an untrained version of an encoder, where the encoder is part of a machine learning model with an encoder-decoder architecture (block 705). During the training of the untrained version of the encoder, encoder parameters are optimized in order to maximize stochastic dependence between a vector embedding set and ground truth data, where the vector embedding set is generated by the untrained version of the encoder (block 710). Next, the machine learning model is deployed as part of a computing system executing one or more software applications, where the machine learning model includes a trained version of the encoder generated during the training (block 715). After block 715, method 700 may end.

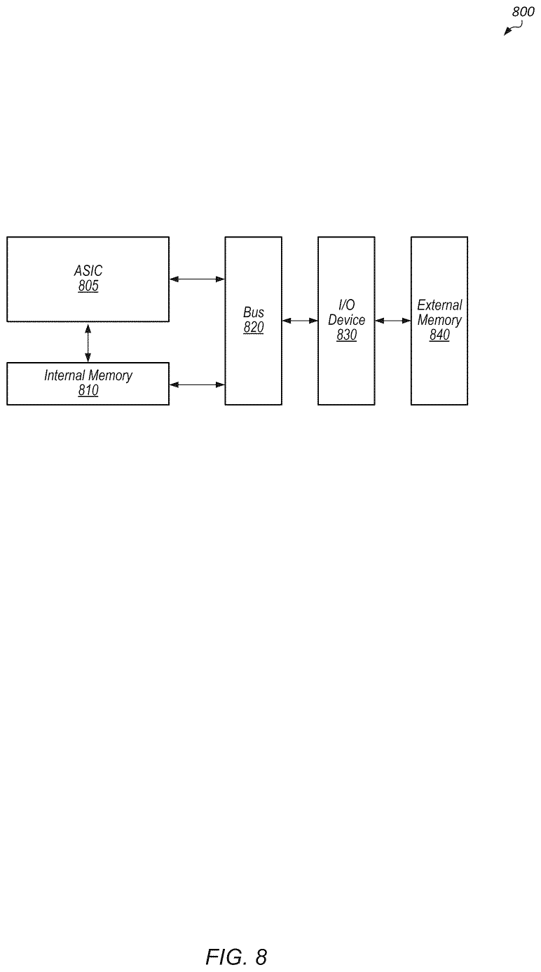

Turning now to FIG. 8, a system 800 for implementing one or more machine learning models is depicted, in accordance with one or more embodiments of the current subject matter. In one embodiment, system 800 may include at least application-specific integrated circuit (ASIC) 805, internal memory 810, bus 820, input/output (I/O) device 830, and external memory 840. System 800 may include other components which are not shown to avoid obscuring the figure. System 800 may be incorporated within a cloud platform (e.g., cloud platform 110 of FIG. 1) or as part of an organization's local computing environment on one or more on-premise servers.

ASIC 805 may be configured implement one or more machine learning models in accordance with the subject matter disclosed herein. ASIC 805 is representative of any type of circuit or processing unit for implementing one or more machine learning models. In other embodiments, a graphics processing unit (GPU), a tensor processing unit (TPU), or another type of processing unit or circuit may be used in place of or in addition to ASIC 805.

In one embodiment, ASIC 805 includes a plurality of neurons organized in a plurality of layers with neurons from one layer connected to neurons from a subsequent layer. The connections between layers may include circuitry and/or logical elements for altering, adjusting, and/or applying mathematical functions to the values of the neurons of a given layer before connecting to the neurons of a subsequent layer. In an example, the plurality of neurons is organized in an array where each neuron comprises a register (e.g., flip-flop), an input connection, and an output connection. ASIC 805 may be coupled to internal memory 810 for storing input and output values. ASIC 805 and internal memory 810 are coupled to bus 820 which is coupled to I/O device 830. I/O device 830 may be coupled to any number of components including external memory 840. In an example, external memory 840 may have a larger capacity than internal memory 810. Additionally, in an example, external memory 840 may have a slower access capability as compared to internal memory 810 which may be accessed with a relatively higher data rate.

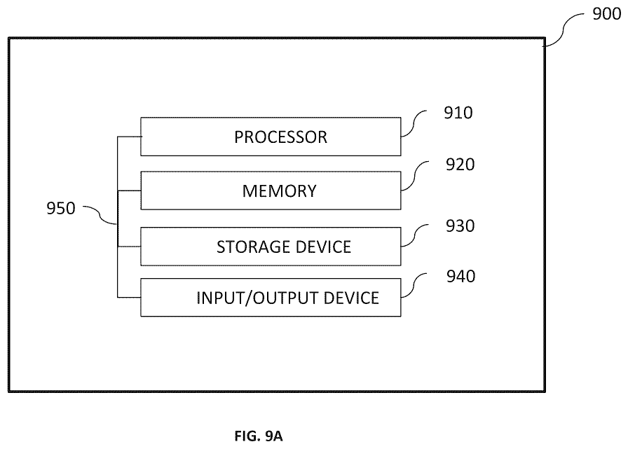

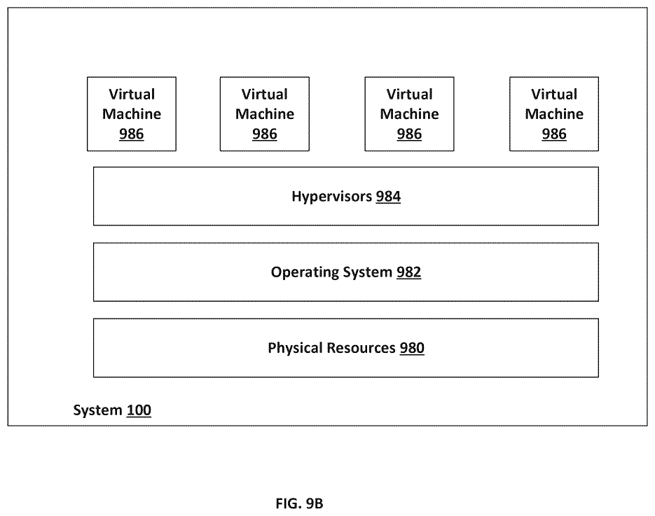

In some implementations, the current subject matter may be configured to be implemented in a system 900, as shown in FIG. 9A. The system 900 may include a processor 910, a memory 920, a storage device 930, and an input/output device 940. Each of the components 910, 920, 930 and 940 may be interconnected using a system bus 950. The processor 910 may be configured to process instructions for execution within the system 900. In some implementations, the processor 910 may be a single-threaded processor. In alternate implementations, the processor 910 may be a multi-threaded processor. The processor 910 may be further configured to process instructions stored in the memory 920 or on the storage device 930, including receiving or sending information through the input/output device 940. The memory 920 may store information within the system 900. In some implementations, the memory 920 may be a computer-readable medium. In alternate implementations, the memory 920 may be a volatile memory unit. In yet some implementations, the memory 920 may be a non-volatile memory unit. The storage device 930 may be capable of providing mass storage for the system 900. In some implementations, the storage device 930 may be a computer-readable medium. In alternate implementations, the storage device 930 may be a floppy disk device, a hard disk device, an optical disk device, a tape device, non-volatile solid state memory, or any other type of storage device. The input/output device 940 may be configured to provide input/output operations for the system 900. In some implementations, the input/output device 940 may include a keyboard and/or pointing device. In alternate implementations, the input/output device 940 may include a display unit for displaying graphical user interfaces.

FIG. 9B depicts an example implementation of the system 100 (of FIG. 1). The system 100 may be implemented using various physical resources 980, such as at least one or more hardware servers, at least one storage, at least one memory, at least one network interface, and the like. The system 100 may also be implemented using infrastructure, as noted above, which may include at least one operating system 982 for the physical resources 980 and at least one hypervisor 984 (which may create and run at least one virtual machine 986). For example, each multitenant application may be run on a corresponding virtual machine 986.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example would a non-transient solid-state memory or a magnetic hard drive or any equivalent storage medium. The machine-readable medium can alternatively or additionally store such machine instructions in a transient manner, such as would a processor cache or other random-access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system comprising: at least one processor; and at least one memory storing instructions that, when executed by the at least one processor, cause operations comprising: training an untrained version of an encoder, wherein the encoder is part of a machine learning model with an encoder-decoder architecture; during the training of the untrained version of the encoder, optimizing encoder parameters in order to increase an amount of stochastic dependence between a vector embedding set and ground truth data, wherein the vector embedding set is generated by the untrained version of the encoder; and deploying the machine learning model during execution of one or more software applications, wherein the machine learning model includes a trained version of the encoder generated during the training.

Example 2: The system of Example 1, wherein the untrained version of the encoder is trained separately from an untrained version of a decoder, and wherein the decoder is part of the machine learning model with the encoder-decoder architecture.

Example 3: The system of any of Examples 1-2, wherein the operations further comprise providing the vector embedding set and the ground truth data as inputs to a loss function.

Example 4: The system of any of Examples 1-3, wherein the operations further comprise generating, by the loss function, a measure of the stochastic dependence between the vector embedding set and the ground truth data.

Example 5: The system of any of Examples 1-4, wherein the operations further comprise training an untrained version of a decoder with the vector embedding set generated by the trained version of the encoder, and wherein the decoder is part of the machine learning model with the encoder-decoder architecture.

Example 6: The system of any of Examples 1-5, wherein the operations further comprise generating, by the machine learning model which includes the trained version of the encoder, output data based on a set of input data.

Example 7: The system of any of Examples 1-6, wherein the operations further comprise providing the output data to the one or more software applications to enable the one or more software application to perform one or more tasks.

Example 8: The system of any of Examples 1-7, wherein the operations further comprise receiving first unstructured data as an input to the untrained version of the encoder.

Example 9: The system of any of Examples 1-8, wherein the operations further comprise generating, by the untrained version of the encoder, the vector embedding set based on the first unstructured data.

Example 10: The system of any of Examples 1-9, wherein the operations further comprise optimizing encoder parameters in order to maximize the amount of stochastic dependence between the vector embedding set and the ground truth data.

Example 11: The system of any of Examples 1-10, wherein the operations further comprise pruning a structure of the encoder to attempt to minimize a size of the encoder while losing less than a threshold amount of information as compared to an unpruned structure of the encoder.

Example 12: A computer-implemented method comprising: training an untrained version of an encoder, wherein the encoder is part of a machine learning model with an encoder-decoder architecture; during the training of the untrained version of the encoder, optimizing encoder parameters in order to increase an amount of stochastic dependence between a vector embedding set and ground truth data, wherein the vector embedding set is generated by the untrained version of the encoder; and deploying the machine learning model as part of a computing system executing one or more software applications, wherein the machine learning model includes a trained version of the encoder generated during the training.

Example 13: The computer-implemented method of Example 12, wherein the untrained version of the encoder is trained separately from an untrained version of a decoder, wherein the decoder is part of the machine learning model with the encoder-decoder architecture.

Example 14: The computer-implemented method of any of Examples 12-13, further comprising providing the vector embedding set and the ground truth data as inputs to a loss function.

Example 15: The computer-implemented method of any of Examples 12-14, further comprising generating, by the loss function, a measure of the stochastic dependence between the vector embedding set and the ground truth data.

Example 16: The computer-implemented method of any of Examples 12-15, further comprising training an untrained version of a decoder with the vector embedding set generated by the trained version of the encoder, wherein the decoder is part of the machine learning model with the encoder-decoder architecture

Example 17: The computer-implemented method of any of Examples 12-16, further comprising generating, by the machine learning model which includes the trained version of the encoder, output data based on a set of input data.

Example 18: The computer-implemented method of any of Examples 12-17, further comprising providing the output data to the one or more software applications to enable the one or more software application to perform one or more tasks.

Example 19: The computer-implemented method of any of Examples 12-18, further comprising optimizing encoder parameters in order to maximize the amount of stochastic dependence between the vector embedding set and the ground truth data.

Example 20: A non-transitory computer readable storage medium storing instructions, which when executed by at least one data processor, result in operations comprising: training an untrained version of an encoder, wherein the encoder is part of a machine learning model with an encoder-decoder architecture; during the training of the untrained version of the encoder, optimizing encoder parameters in order to increase an amount of stochastic dependence between a vector embedding set and ground truth data, wherein the vector embedding set is generated by the untrained version of the encoder; and deploying the machine learning model as part of a computing system executing one or more software applications, wherein the machine learning model includes a trained version of the encoder generated during the training.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A system comprising:
at least one processor; and
at least one memory storing instructions that, when executed by the at least one processor, cause operations comprising:
training an untrained version of an encoder, wherein the encoder is part of a machine learning model with an encoder-decoder architecture;
during the training of the untrained version of the encoder, optimizing encoder parameters in order to increase an amount of stochastic dependence between a vector embedding set and ground truth data, wherein the vector embedding set is generated by the untrained version of the encoder; and
deploying the machine learning model during execution of one or more software applications, wherein the machine learning model includes a trained version of the encoder generated during the training.

2. The system of claim 1, wherein the untrained version of the encoder is trained separately from an untrained version of a decoder, and wherein the decoder is part of the machine learning model with the encoder-decoder architecture.

3. The system of claim 1, wherein the operations further comprise providing the vector embedding set and the ground truth data as inputs to a loss function.

4. The system of claim 3, wherein the operations further comprise generating, by the loss function, a measure of the stochastic dependence between the vector embedding set and the ground truth data.

5. The system of claim 1, wherein the operations further comprise training an untrained version of a decoder with the vector embedding set generated by the trained version of the encoder, and wherein the decoder is part of the machine learning model with the encoder-decoder architecture.

6. The system of claim 1, wherein the operations further comprise generating, by the machine learning model which includes the trained version of the encoder, output data based on a set of input data.

7. The system of claim 6, wherein the operations further comprise providing the output data to the one or more software applications to enable the one or more software application to perform one or more tasks.

8. The system of claim 1, wherein the operations further comprise receiving first unstructured data as an input to the untrained version of the encoder.

9. The system of claim 8, wherein the operations further comprise generating, by the untrained version of the encoder, the vector embedding set based on the first unstructured data.

10. The system of claim 1, wherein the operations further comprise optimizing encoder parameters in order to maximize the amount of stochastic dependence between the vector embedding set and the ground truth data.

11. The system of claim 1, wherein the operations further comprise pruning a structure of the encoder to attempt to minimize a size of the encoder while losing less than a threshold amount of information as compared to an unpruned structure of the encoder.

12. A computer-implemented method comprising:
training an untrained version of an encoder, wherein the encoder is part of a machine learning model with an encoder-decoder architecture;
during the training of the untrained version of the encoder, optimizing encoder parameters in order to increase an amount of stochastic dependence between a vector embedding set and ground truth data, wherein the vector embedding set is generated by the untrained version of the encoder; and
deploying the machine learning model as part of a computing system executing one or more software applications, wherein the machine learning model includes a trained version of the encoder generated during the training.

13. The computer-implemented method of claim 12, wherein the untrained version of the encoder is trained separately from an untrained version of a decoder, wherein the decoder is part of the machine learning model with the encoder-decoder architecture.

14. The computer-implemented method of claim 12, further comprising providing the vector embedding set and the ground truth data as inputs to a loss function.

15. The computer-implemented method of claim 14, further comprising generating, by the loss function, a measure of the stochastic dependence between the vector embedding set and the ground truth data.

16. The computer-implemented method of claim 12, further comprising training an untrained version of a decoder with the vector embedding set generated by the trained version of the encoder, wherein the decoder is part of the machine learning model with the encoder-decoder architecture.

17. The computer-implemented method of claim 12, further comprising generating, by the machine learning model which includes the trained version of the encoder, output data based on a set of input data.

18. The computer-implemented method of claim 17, further comprising providing the output data to the one or more software applications to enable the one or more software application to perform one or more tasks.

19. The computer-implemented method of claim 12, further comprising optimizing encoder parameters in order to maximize the amount of stochastic dependence between the vector embedding set and the ground truth data.

20. A non-transitory computer readable storage medium storing instructions, which when executed by at least one data processor, result in operations comprising:
training an untrained version of an encoder, wherein the encoder is part of a machine learning model with an encoder-decoder architecture;
during the training of the untrained version of the encoder, optimizing encoder parameters in order to increase an amount of stochastic dependence between a vector embedding set and ground truth data, wherein the vector embedding set is generated by the untrained version of the encoder; and
deploying the machine learning model as part of a computing system executing one or more software applications, wherein the machine learning model includes a trained version of the encoder generated during the training.
